(19) United States
(12) Patent Application Publication
(10) Pub. No.: US 2016/0065937 A1
(43) Pub. Date: Mar. 3, 2016

(54) ASSIST APPARATUS FOR VISUALLY IMPAIRED PERSON AND METHOD FOR CONTROLLING THE SAME

(71) Applicant: Samsung Electronics Co., Ltd., Gyeonggi-do (KR)

(72) Inventors: Bo-Ram BAE, Busan (KR); Kyung-Min LEE, Ulsan (KR); Seong-Yeob KIM, Busan (KR); Kyung-Hun LEE, Busan (KR)

(73) Assignee: Samsung Electronics Co., Ltd.

(21) Appl. No.: 14/800,044

(22) Filed: Jul. 15, 2015

(30) Foreign Application Priority Data
Sep. 3, 2014 (KR) 10-2014-0117258

(51) Int. Cl. H04N 13/02; G01C 3/08; A45B 3/00; G01B 11/14; G01B 11/22

(52) U.S. Cl. CPC H04N 13/02; G01B 11/14; G01B 11/22; A45B 3/00; G01C 3/08; H04N 2013/0081

(57) ABSTRACT

An assist apparatus for a visually impaired person is provided. The assist apparatus includes an image acquisition unit including a sensor unit, a gravity sensor, at least one retractable and extendable protrusion, a motor drive, and a processor. The sensor unit acquires a depth image including a distance value for an obstacle in front of the person. The gravity sensor detects an inclined angle of the image acquisition unit in relation to a ground surface upon which the person is walking. The motor drive drives a motor to cause the at least one protrusion to extend or retract. The processor generates 3-Dimensional (3D) data using the detected inclined angle and the acquired depth image, converts the distance value into a height value, and controls the motor drive to cause the at least one protrusion to extend or retract to the height value.

### PRIORITY

This application claims priority under 35 U.S.C. § 119(a) to Korean Patent Application Serial No. 10-2014-0117258, which was filed in the Korean Intellectual Property Office on Sep. 3, 2014, the entire content of which is incorporated herein by reference.

### BACKGROUND

1. Field of Invention

The present invention relates generally to an assist apparatus for a visually impaired person and a method for controlling the same.

2. Description of the Related Art

A visually impaired person may use an object, such as a walking stick, to sense what is in front of him or her.

In particular, the walking stick informs the visually impaired person of the presence/absence of an obstacle in front of the user. However, the conventional walking stick does not assist the visually impaired person in ascertaining other situations.

Accordingly, a technique is needed for enabling a visually impaired person to sense things in front of the person more efficiently so as to actively ascertain obstacles in front of the person.

### SUMMARY

The present invention has been made to address at least the problems and disadvantages described above, and to provide at least the advantages described below.

Accordingly, an aspect of the present invention is to provide an assist apparatus for a visually impaired person which converts a distance value of an approaching obstacle into a height value and controls at least one protrusion to extend or retract to the height value so that the user may recognize the protrusion by a tactile sense and thus, actively avoid the obstacle in front of the user.

Accordingly, another aspect of the present invention is to maintain a position of a sensor unit included in the assist apparatus within a pre-set angle range, even when the user carries the assist apparatus while walking causing the assist apparatus to be tilted up or down, so that the sensing accuracy of the sensor unit can be improved.

Accordingly, another aspect of the present invention is to sense a region obscured by the obstacle or a region out of a view angle range of the sensor unit.

In accordance with an aspect of the present invention, an assist apparatus for a visually impaired person is provided. The assist apparatus includes an image acquisition unit including a sensor unit, a gravity sensor, at least one retractable and extendable protrusion, a motor drive, and a processor. The sensor unit acquires a depth image including a distance value for an obstacle in front of the person. The gravity sensor detects an inclined angle of the image acquisition unit in relation to a ground surface upon which the person is walking. The motor drive drives a motor to cause the at least one protrusion to extend or retract. The processor generates 3-Dimensional (3D) data using the detected inclined angle and the acquired depth image, converts the distance value into a height value, and controls the motor drive to cause the at least one protrusion to extend or retract to the height value.

In accordance with another aspect of the present invention, a method of controlling an assist apparatus for a visually impaired person is provided. The method includes acquiring a depth image, including a distance value for an obstacle in front of the person, through a sensor unit, detecting an inclined angle of the sensor unit in relation to a ground surface upon which the person is walking, through a gravity sensor, generating 3D data using the detected inclined angle and the acquired depth image, converting the distance value into a height value, and controlling at least one protrusion to extend or retract to the height value.

### BRIEF DESCRIPTION OF THE DRAWINGS

The above and other aspects, features, and advantages of the present invention will be more apparent from the following detailed description taken in conjunction with the accompanying drawings, in which:

FIG. 1 is schematic diagram illustrating an assist apparatus, according to an embodiment of the present invention;

FIG. 2 is diagram illustrating a user using an assist apparatus, according to an embodiment of the present invention;

FIG. 3 is a schematic diagram illustrating protrusions on a plate of the assist apparatus, according to an embodiment of the present invention;

FIGS. 4A, 4B, 5A, 5B, 6A, 6B, 7A, 7B, 8A and 8B are schematic diagrams illustrating an operation of an image acquisition unit of the assist apparatus, according to an embodiment of the present invention;

FIGS. 9A and 9B are schematic diagrams illustrating a user using an assist apparatus, according to an embodiment of the present invention;

FIGS. 10 and 11 are schematic diagrams illustrating an assist apparatus, according to an embodiment of the present invention; and

FIG. 12 is a flowchart of a method for controlling the assist apparatus, according an embodiment of the present invention.

### DETAILED DESCRIPTION OF EMBODIMENTS OF THE PRESENT INVENTION

Hereinafter, embodiments of the present invention will be described in conjunction with the accompanying drawings. The present invention may have various modifications and embodiments, and specific embodiments thereof are illustrated in the drawings and described in detail. However, it should be understood that the present invention is not limited to the particular embodiments, but includes all modifications, equivalents, and/or alternatives within the spirit and scope of the present invention. In the description of the drawings, identical or similar reference numerals are used to designate identical or similar elements. Detailed descriptions of constructions or processes known in the art may be omitted to avoid obscuring the subject matter of the present invention

As used herein, the singular forms “a”, “an”, and “the” are intended to include the plural forms as well, unless expressly stated otherwise. It will be further understood that the terms “includes”, “comprises”, “including”, and/or “comprising”, when used herein, specify the presence of stated features, integers, steps, operations, elements, and/or components, but do not preclude the presence or addition of one or more other features integers, steps, operations, elements, components, and/or groups thereof As used herein, the term “and/or” includes any and all combinations and arrangements of one or more of the associated listed items.

In the case where an element is referred to as being “connected” to or “accessed” by another element, it should be understood that not only may the element be directly connected to or accessed by the other element, but also a new element may exist between the two elements. In the case where an element is referred to as being “directly connected to” or “directly accessing” another element, it should be understood that no element exists between the two elements.

As used herein, terms are used merely for describing specific embodiments and are not intended to limit the scope of the present invention. Unless defined otherwise, all terms used herein, including technical and scientific terms, have the same meaning as commonly understood by those of skill in the art to which various embodiments of the present invention pertain. Such terms as those defined in a generally used dictionary are to be interpreted to have meanings equivalent to the contextual meanings in the relevant field of art, and are not to be interpreted to have ideal or excessively formal meanings unless clearly defined in various embodiments of the present invention.

Hereinafter, an assist apparatus will be described with reference to the accompanying drawings.

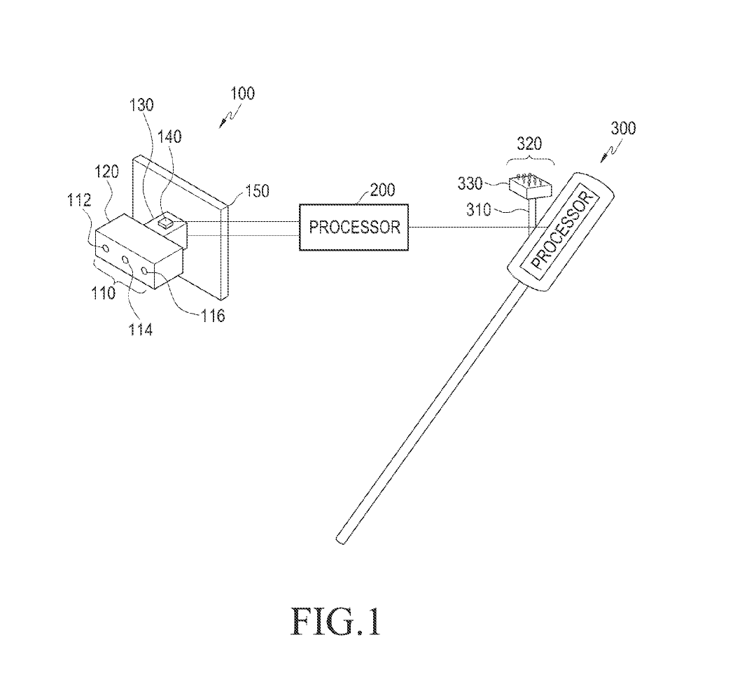

FIG. 1 is schematic diagram illustrating an assist apparatus, according to an embodiment of the present invention.

Referring to FIG. 1, an assist apparatus for a visually impaired person is provided. The assist apparatus includes an image acquisition unit 100, a processor 200, and a stick 300.

The image acquisition unit 100 acquires a depth image, including a distance value, for an obstacle 400 in front of the image acquisition unit 100. The image acquisition unit 100 includes a sensor unit 120 formed by at least one of a 3D sensor and a stereo camera.

The 3D sensor senses an obstacle 400 by emitting an electromagnetic wave from a lens 110 and then receiving the electromagnetic wave back as the wave bounces off the obstacle 400. The electromagnetic wave emitted from the 3D sensor may be an infrared ray. The 3D sensor is capable of generating a 3-Dimensional (3D) distance value for the obstacle 400 positioned in front of the image acquisition unit 100. In addition, the 3D sensor generates a depth image based on the generated 3D distance value. The depth image is an image expressed by the 3D distance value for the obstacle 400 positioned in front of the image acquisition unit 100.

The stereo camera detects an obstacle 400 in front of the camera through an image captured through the lens 110. The stereo camera analyzes the image and generates the 3D distance value for the obstacle 400 positioned in front of the stereo camera. In addition, the stereo camera generates a depth image based on the 3D distance value.

Accordingly, the image acquisition unit 100, including the sensor unit 120 formed by at least one of the 3D sensor and the stereo camera, acquires a depth image, including a distance value for a sensed object in front of the user.

One or more lenses 110 are formed on a surface of the sensor unit 120. For example, a plurality of lenses 112, 114, 116 may be provided on a front surface of the sensor unit 120. Further, the front surface of the sensor unit 120 may be formed such that the width is longer than the height and the plurality of lenses 112, 114 and 116 are positioned on the front surface. The plurality of lenses may be positioned, for example, to be aligned horizontally or vertically or may be positioned in another manner. Accordingly, the sensor unit 120 senses an obstacle 400 in front of the image acquisition unit 100 through the lens 110 formed on the front surface of the sensor unit 120.

A connection unit 130 connects the rear surface of the sensor unit 120 to a front surface of a support fixture 150 so as to interconnect the sensor unit 120 and the support fixture 150.

The support fixture 150 is formed of a plate 330. The plate 330 may be shaped to be flat. The rear surface of the support fixture 150 may contact the front surface of a user. Accordingly, when the rear surface of the support fixture 150 is in contact with the front surface of the user, the sensor unit 120 connected with the support fixture 150 may sense an obstacle 400 positioned in front of the user.

The gravity sensor 140 detects the inclined angle of the image acquisition unit 100 in relation to the ground. The gravity sensor 140 is attached to the top of the connection unit 130. Accordingly, when the image acquisition unit 100 is inclined in relation to the ground, the gravity sensor 140 is also equally inclined. The gravity sensor 140 extracts the inclined angle of the gravity sensor 140 in relation to the ground. In addition, since the gravity sensor 140 is attached to the top of the connection unit 130, the extracted angle is also the inclined angle of the image acquisition unit 100 in relation to the ground. Accordingly, the gravity sensor 140 detects the inclined angle of the image acquisition unit 100 in relation to the ground.

The stick 300 is formed in the shape of a rod and allows the user to support himself/herself on the ground. The stick 300 includes a grip having attached thereto the plate 330. The plate 330 includes a motor drive 310 and one or more protrusions 320.

The motor drive 310 drives a motor which controls the protrusions 320 to extend and retract.

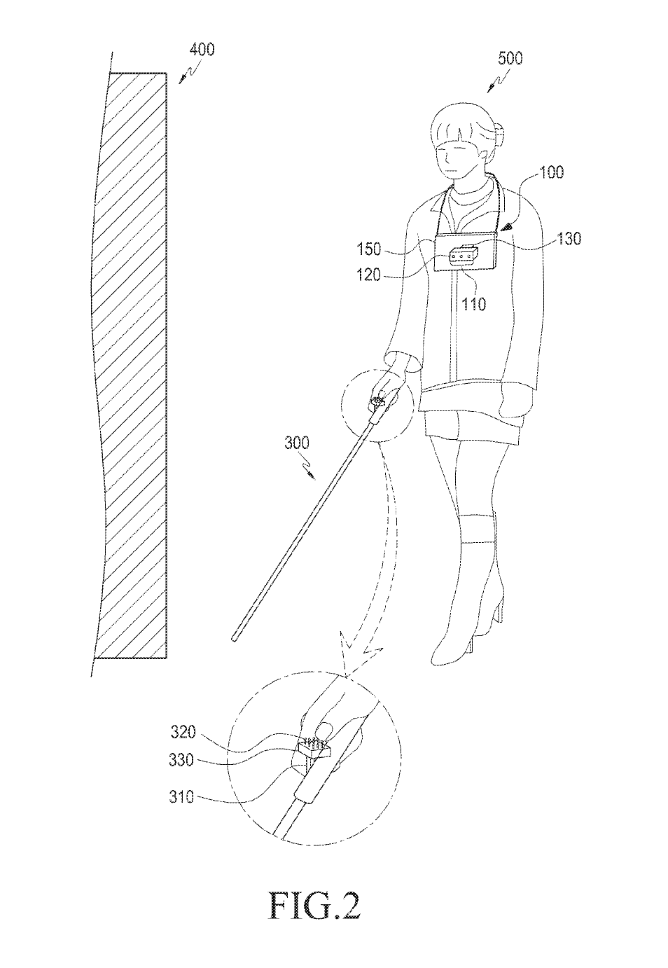

FIG. 2 is diagram illustrating a user using an assist apparatus, according to an embodiment of the present invention.

Referring to FIG. 2, the user 500 holds the grip of the stick 300 and positions one of the user's fingers, for example, the thumb, on the plate 330 to sense the extension and retraction of the protrusions 320.

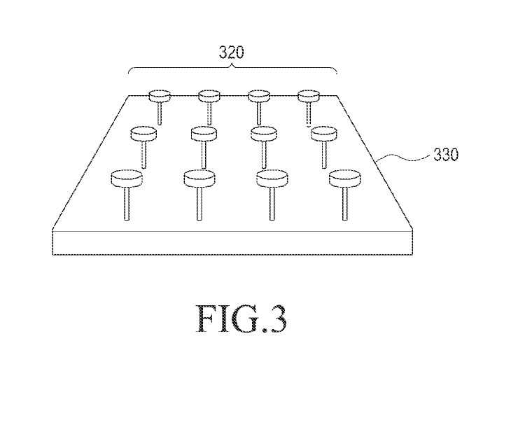

FIG. 3 is a schematic diagram illustrating protrusions on a plate of the assist apparatus, according to an embodiment of the present invention.

Referring to FIG. 3, the plate 330 formed with protrusions 320 is provided. The plate 330 may formed in a size similar to a size of the pad of a user's finger, such as the user's thumb pad. Accordingly, when the protrusions 320 extend or retract, the user 500 may sense the extension or retraction of the protrusions 320 using the finger.

Referring back to FIG. 1, the processor 200 generates 3D data using the inclined angle received from the gravity sensor 140 and the depth image received from the image acquisition unit 100. The processor 200 generates the 3D data corresponding to the depth image based on the inclined angle of the image acquisition unit 100. The depth image may be generated when the image acquisition unit 100 is inclined. Accordingly, when the 3D data is generated, it is necessary to consider the inclined degree of the depth image. Accordingly, the processor 200 generates the 3D data in consideration of the inclined degree of the image acquisition unit 100 in relation to the ground. Thus, the generated 3D data is highly accurate data in which the inclined degree of the image acquisition unit 100 is taken into consideration.

In addition, the processor 200 converts the distance value, included in the 3D data, into a height value. The 3D data is three-dimensionally formed data representing the distance value from the image acquisition unit 100 to the obstacle 400. Accordingly, the distance value may be the distance from the user 500 to the obstacle 400. Thus, the 3D data is three-dimensionally formed data for the distance value from the user 500 to the obstacle 400. The processor 200 converts the distance value included in the 3D data to a height value of the protrusions 320 when the protrusions 320 are extended. The height value in this state will be referred to as a “protruding height value” for the convenience of description. For example, when the distance value to the obstacle 400 is small, the processor 200 sets the protruding height value of the protrusions 320 to be small. When the distance value to the obstacle 400 is large, the processor 200 sets the protruding height value of the protrusions 320 to be larger. The processor 200 generates a motor control signal including the height value. That is, the motor control signal includes the protruding height value of the protrusions 320. In addition, the processor 200 transmits the motor control signal to the motor drive 310. The motor drive 310 receives the motor control signal and drives the motor based on the height value included in the motor control signal to control the protrusions 320 to extend or retract. Accordingly, the processor 200 controls the motor drive 310 to cause the protrusions 320 to extend or retract to the protruding height value.

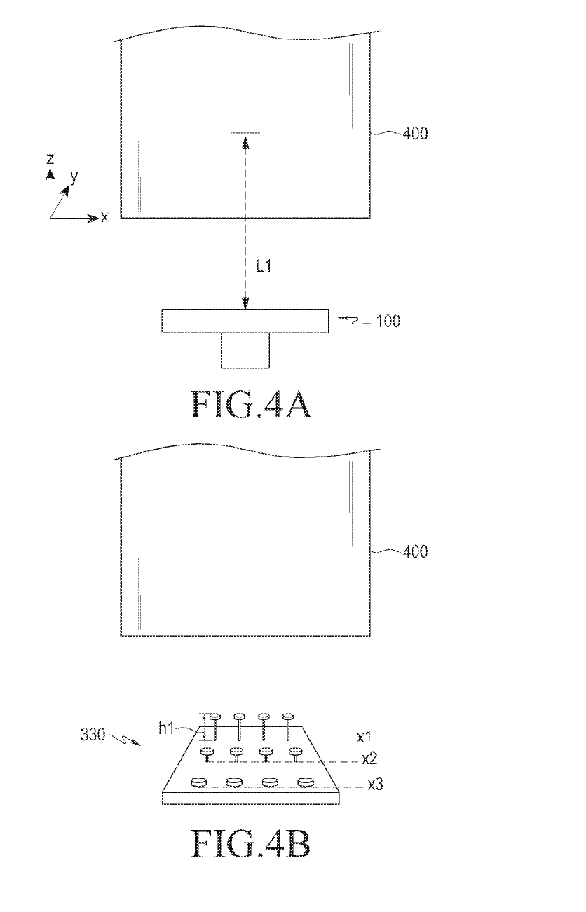

FIGS. 4A, 4B, 5A, 5B, 6A, 6B, 7A, 7B, 8A and o 8B are schematic diagrams illustrating an operation of an image acquisition unit of the assist apparatus, according to an embodiment of the present invention.

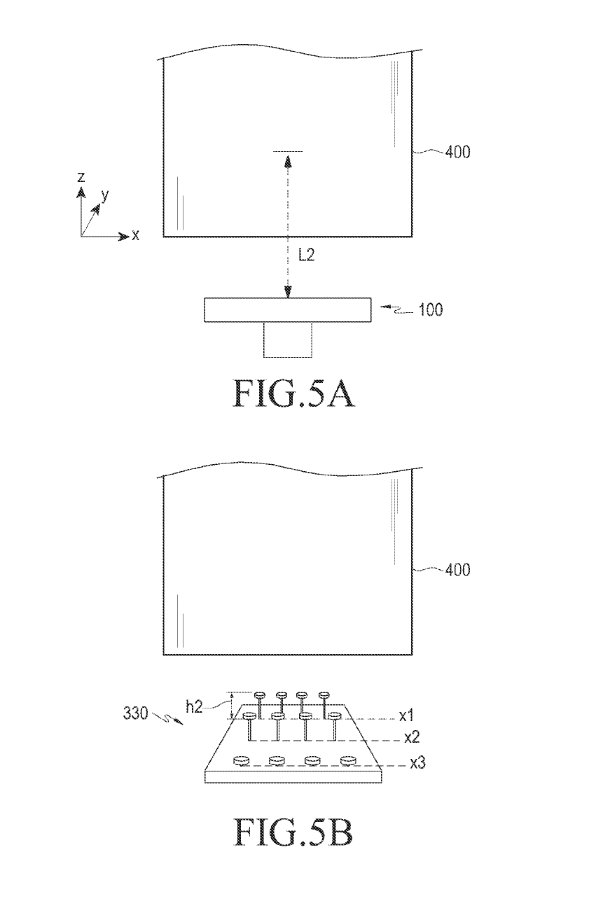

Referring to FIGS. 4A, 4B, 5A and 5B, the processor 200 transmits the motor control signal, including the height value, to the motor drive 310 to control the protrusions 320 to extend or retract. For example, the processor 200 transmits, to the motor drive 310, the motor control signal, which increases or decreases the protruding height value of the protrusions 320 based on the distance value to the obstacle 400.

As shown in FIG. 4A, the distance value between the obstacle 400 and the image acquisition unit 100 is L1. As shown in FIG. 5A, the distance value between the obstacle 400 and the image acquisition unit 100 is L2. In this case, L1 is longer than L2. Accordingly, the protruding height value h1, shown in FIG. 4B, of the protrusions 320 which correspond to L1 are controlled to be higher than the protruding height value h2, shown in FIG. 5B, of the protrusions 320 corresponding to L2.

For example, referring to FIG. 4B, a one or more protrusions 320 may be provided on the plate 330, as described above with reference to FIG. 3. In addition, the protrusions 320 may be arranged in x rows and y columns. For example, the protrusions 320 are arranged in rows x1, x2 and x3 and columns y1, y2, y3 and y4. When the distance value is small, the processor 200 controls the protrusions 320, which are provided in the x row which is the closest to the obstacle 400 to extend first. For example, when the obstacle 400 becomes closer to the image acquisition unit 100, the processor 200 controls the protrusions 320 that are provided in row x1, which is the closest to the obstacle 400, to extend. In addition, for example, as illustrated in FIG. 5B, when the distance value between the obstacle 400 and the image acquisition unit 100, shown in FIG. 5A, is smaller (i.e., closer) than the distance value of FIG. 4A, the processor 200 also controls the protrusions 320 that are formed in row x2, as well as the protrusions 320 formed in row x1, to sequentially extend. That is, as the distance value between the obstacle 400 and the image acquisition unit 100 is gradually reduced, the processor 200 controls the rows of protrusions 320 to sequentially extend, beginning from the row of protrusions 320 that is the closest to the obstacle 400.

Accordingly, when the user 500 approaches the obstacle 400, the user senses the protrusions 320 closest to the obstacle 400 extend, so that the user begins to recognize the presence of the obstacle 400. In addition, as the obstacle 400 gradually approaches the user 500, the user 500 is able to sense, not only the extension of the protrusions 320 that are the closest to the obstacle 400, but also the extension of the next row of protrusions 320, thereby being able to sense that the obstacle 400 gradually approaches the user 500.

Accordingly, FIGS. 4A, 4B, 5A and 5B illustrate the case when the protrusions 320 extend as the obstacle 400 approaches in front of the user 500. In addition, as the obstacle 400 in front of the user 500 approaches the user 500, the rows of the protrusions 320 sequentially extend so that the user 500 is able to recognize that the obstacle 400 gradually is becoming closer to the user 500.

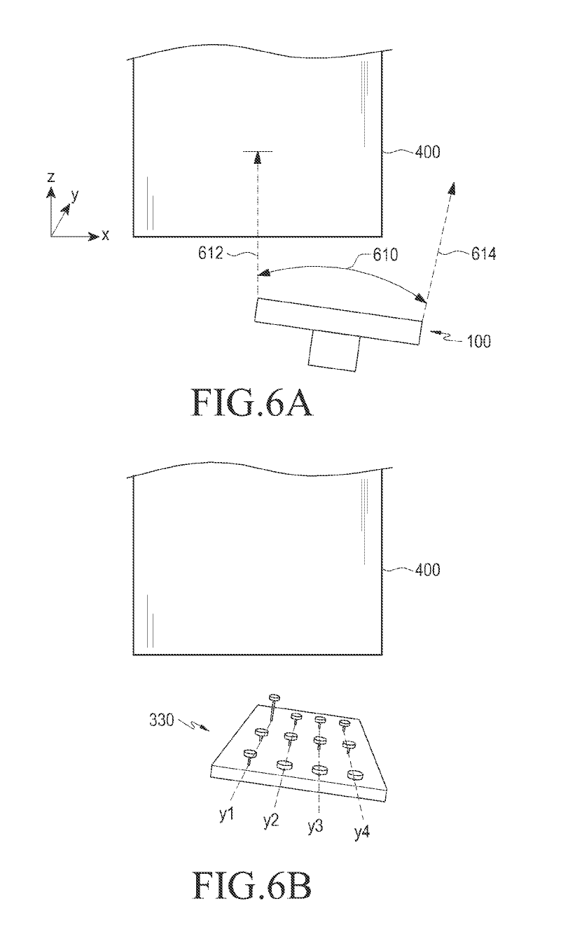

Referring to FIGS. 6A, 6B, 7A, 7B, 8A and 8B, when the obstacle 400 is sensed at one side of a view angle of the image acquisition unit 100, the processor 200 additionally controls the protrusions 320 that correspond to the side of the view angle at which the obstacle 400 is sensed, to extend.

For example, as illustrated in FIG. 6A, when the sensed obstacle 400 approaches from the left side 612 of the view angle 610 of the image acquisition unit 100, the processor 200 controls the protrusions 320 of column y1 to extend first, as illustrated in FIG. 6B. That is, column y1 is on the left side of the plate 330, which corresponds to the left side 612 of the view angle 610. Accordingly, when the obstacle 400 approaches the user 500 from the left side, the processor 200 controls the protrusions 320 that are formed on the left side to extend first. Thus, the user 500 is able to sense that the protrusions 320 formed on the left side extend first, thereby recognizing that the obstacle 400 approaches the user 500 from the left side.

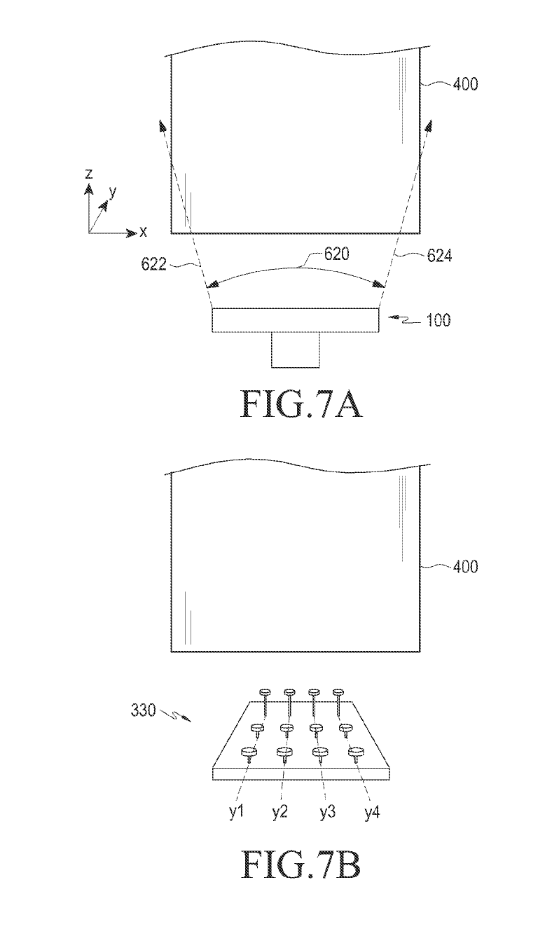

In another example, as illustrated in FIG. 7A, when the sensing of the obstacle 400 approaches from the front of the of the image acquisition unit 100 and covers the entire view angle 620 of the image acquisition unit 100, the processor 200 controls all of the protrusions 320 in columns y1, y2, y3, and y4 of the plate 330 to extend first, as illustrated in FIG. 7B. Columns y1, y2, y3 and y4 of the plate 330 correspond to the entire view angle 620. Accordingly, when the obstacle 400 approaches the user 500 from the front, the processor 200 controls all of the protrusions 320 to extend. Thus, the user 500 is able to sense that all of the protrusions 320 extend, thereby recognizing that the user 500 approaches the obstacle 400 from the front of the user 500.

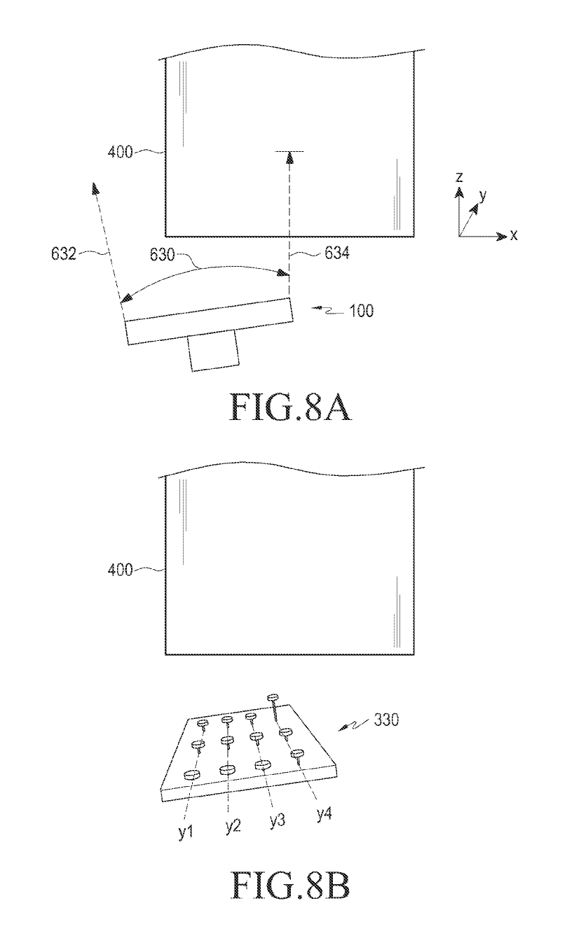

In another example, as illustrated in FIG. 8A, when the sensed obstacle 400 approaches from the right side 634 of the view angle 630 of the image acquisition unit 100, the processor 200 controls the protrusions 320 in column y3 to extend first, as illustrated FIG. 8B. That is, column y3 is formed on the right portion of the plate 330, which corresponds to the right side 634 of the view angle 630. Accordingly, when the user 500 approaches the obstacle 400 from the right side, the processor 600 controls the protrusions 320, which are formed on the right side, to extend first. Thus, the user 500 is able to sense that the protrusions 320 formed on the right side extend first, thereby recognizing that the obstacle 400 is becoming closer to the user 500 from the right side of the user 500.

Accordingly, when a distance value included in generated 3D data is converted into a protruding height value to control the protrusions 320 to extend or retract to the protruding height value, the user 500 is able to tactually recognize the protrusions 320 so that the user 500 may actively avoid an obstacle 400 in front of the user 500.

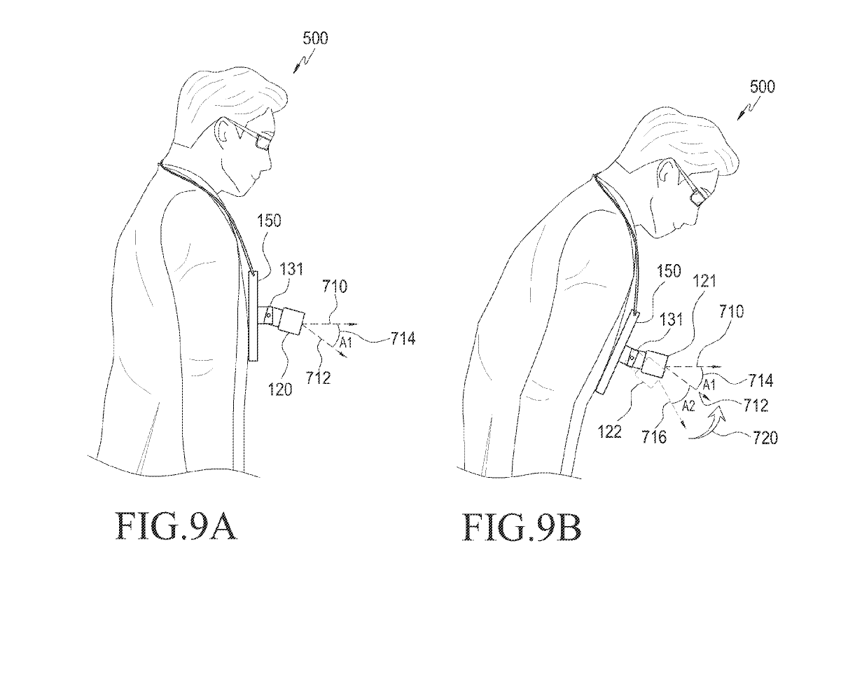

FIGS. 9A and 9B are schematic diagrams illustrating a user using an assist apparatus, according to an embodiment of the present invention.

Referring to FIGS. 9A and 9B, in another embodiment of the present invention, the assist apparatus may further include a servo motor 131, which is attached to the sensor unit 120 to adjust the angle of the sensor unit 120. The servo motor 131 refers to a motor that constantly maintains the inclined angle of the sensor unit 120 in relation to the ground.

The servo motor 131 is attached to the sensor unit 120 of the image acquisition unit 100 and the support fixture 150. Accordingly, one side of the servo motor 131 is attached to the sensor unit 120, and the other side of the servo motor 131 is attached to the support fixture 150.

In addition, the servo motor 131 is provided with a motor. Accordingly, the servo motor 131 adjusts the angle of the sensor unit 120.

Referring back to FIG. 1, the gravity sensor 140 may be attached to the upper end of the servo motor 131 to detect the inclined angle of the sensor unit 120 in relation to the ground. The processor 200 receives data related to the inclined angle of the sensor unit 120 in relation to the ground from the gravity sensor 140. When the received angle is outside of a pre-set angle range, the processor 200 controls and drives the servo motor 131 such that the sensor unit 120 is adjusted to be positioned within the pre-set angle range.

For example, as illustrated in FIG. 9A, the gravity sensor 140 detects the inclined angle (A1) 714 of the sensor unit 120 in relation to the ground (i.e., the angle formed between the plane 710 running parallel to the ground and the plane 712 running parallel to the sensor unit 120 when the sensor unit 120 is in position 121).

When the user 500 inclines the user's body forward, as illustrated in FIG. 9B, the sensor unit 120 is inclined downwardly (i.e., the sensor unit 120 is in position 122) and the gravity sensor 140 detects the inclined angle of the sensor unit 120 in relation to the ground. The detected inclined angle is the sum of inclined angle (A1) 714 and inclined angle (A2) 720 (i.e., the angle formed between the plane 710 running parallel to the ground and the plane 716 running parallel to the sensor unit 120 when the sensor unit 120 is in position 122). The detected inclined angle (A1+A2) may be, for example, 45 degrees.

The processor 200 receives the detected inclined angle from the gravity sensor 140. When the received inclined angle is outside of the pre-set angle range, the processor 200 controls and drives the servo motor 131 to reposition the sensor unit 120 within the pre-set angle range.

For example, if the pre-set angle range is 15 degrees, the processor 200 controls the servo motor 131 to maintain the sensor unit 120 to be positioned within the pre-set angle range of 15 degrees (A1). If the received inclined angle is outside of the pre-set angle range, to reposition the sensor unit 120 to be within the pre-set angle range, the processor 200 generates a motor control signal and transmits the motor control signal to the servo motor 131. For example, the processor 200 generates the motor control signal, including a command to reposition the sensor unit 120 upward by 30 degrees (A2) (as indicated by arrow 720) and transmits the motor control signal to the servo motor 131. Then, the servo motor 131 receives the motor control signal and drives the motor, in response to the received motor control signal, to change the angle of the sensor unit 120. For example, the servo motor 131 drives the motor to change the angle of the sensor unit 120 by 30 degrees (A2) upwardly (as indicated by arrow 720). Accordingly, the position of sensor unit 120 is changed from the position 122 to the position 121 to change the angle upwardly. Thus, the sensor unit 120 is positioned within the pre-set angle range.

Therefore, according to the embodiment of the present invention illustrated with reference to FIGS. 9A and 9B, an assist apparatus may further include the servo motor 131 attached to the sensor unit 120 to constantly maintain the inclined angle of the sensor unit 120 in relation to the ground. Thus, when the user 500 carries the assist apparatus while walking, the sensor unit 120 included in the assist apparatus is controlled to be constantly positioned within a pre-set angle range even when the assist apparatus is tilted up and down due to walking. Since the position of the sensor unit 120 is constantly maintained, even when the user 500 walks, the sensing accuracy of the sensor unit 120 is improved.

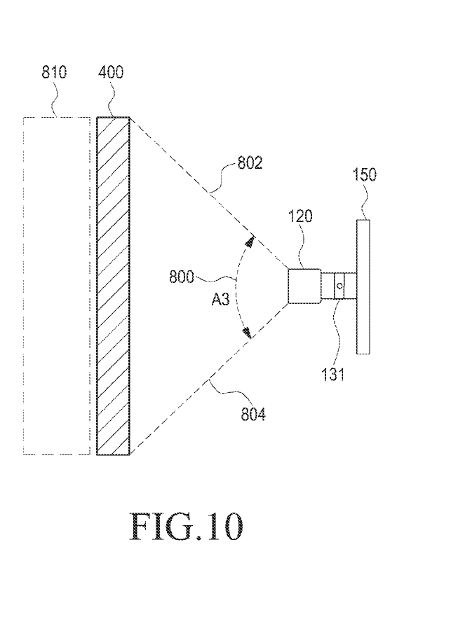

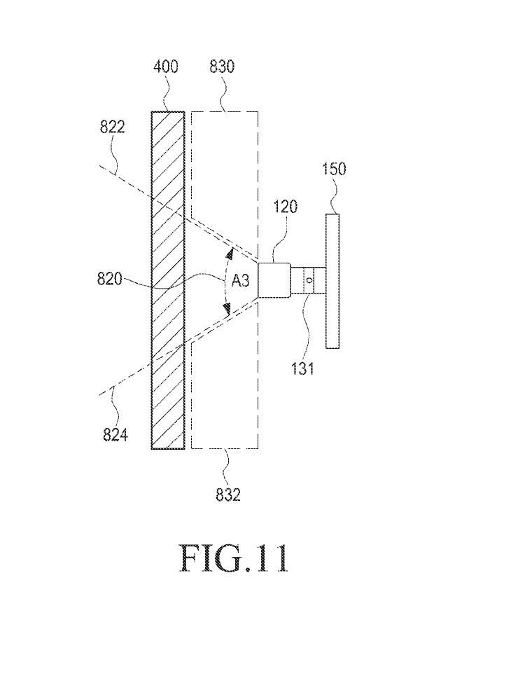

FIGS. 10 and 11 are schematic diagrams illustrating an assist apparatus, according to an embodiment of the present invention.

Referring to FIGS. 10 and 11, in another embodiment of the present invention, the processor 200 generates a depth image for a region obscured by the obstacle 400 or a depth image for an area outside of the range of the view angle of the sensor unit 120.

The image acquisition unit 100 includes the sensor unit 120. The sensor unit 120 is formed by at least one of a 3D sensor and a stereo camera, as described above with reference to FIG. 1. Each of the 3D sensor and the stereo camera included in the sensor unit 120 may have a view angle. The view angle refers to a widest angle which may be sensed by the 3D sensor or the stereo camera. For example, as illustrated in FIG. 10, the view angle 800 of the sensor unit 120 is angle A3 formed between the dotted lines 802 and 804.

When an obstacle 400 exists in front of the image acquisition unit 100, as illustrated in FIG. 10, the region 810 positioned behind the obstacle 400 cannot be sensed. Accordingly, the sensor unit 120 generates data for the depth image for the region 810 so that the non-sensed region 810 may be expressed in proportion to the height of the sensor unit 120 and the highest height of the obstacle 400 within the view angle. Accordingly, the sensor unit 120 generates the depth image based on the view angle 800, such as the angle A3.

As another example, as illustrated in FIG. 11, the view angle 820 of the sensor unit 120 is angle A3 formed between the dotted lines 822 and 824. Accordingly, the sensor unit 120 generates the depth image based on the view angle 820, such as the angle A3. However, the area outside of the view angle 820 cannot be sensed by the sensor unit 820. That is, the region 830, above the dotted line 822, and the region 832, below the dotted line 822, cannot be sensed by the sensor unit 120, and since these regions are outside the range of the view angle 820. Accordingly, the processor 200 generates data for a depth image corresponding to the region 832, below the range of the view angle 820 of the sensor unit 120, and expresses the non-sensed region 832 as if there is an obstacle in the form of the region 832 below the view angle 820. Also, the processor 200 generates data for a depth image corresponding to the region 830, above the range of the view angle 820 of the sensor unit 120, and expresses the non-sensed region 830 as if there is an obstacle in the form of the region 830 above the view angle 820.

Accordingly, the processor 200 generates a depth image for a region obscured by the obstacle 400 or a depth image out of the view angle of the sensor unit 120.

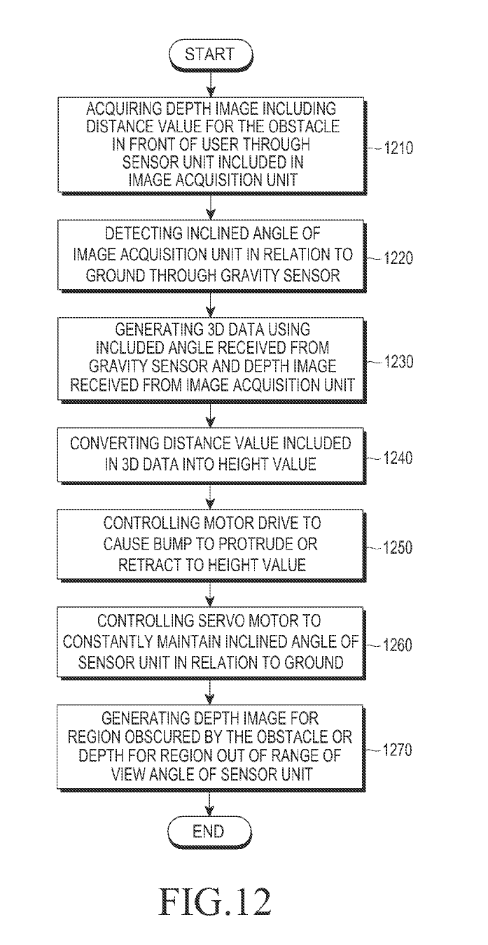

FIG. 12 is a flowchart of a method for controlling the assist apparatus, according an embodiment of the present invention.

Referring to FIG. 12, a method of controlling an assist apparatus for a visually impaired person, according to an embodiment of the present invention is provided.

In step 1210, a depth image, including a distance value for an obstacle 400 in front of the user 500, is acquired through the sensor unit 120 included in the image acquisition unit. That is, the processor 200 controls the image acquisition unit 100 to acquire the depth image, including a distance value for an obstacle 400 in front of the user 500. The distance value refers to the distance from the user 500 to the obstacle 400. In step 1220 the inclined angle of the image acquisition unit 100 in relation to the ground is detected through the gravity sensor 140, which is attached to the connection unit 130 of the image acquisition unit 100. That is, the processor 200 controls the gravity sensor 140 to detect the inclined angle of the image acquisition unit 100 in relation to the ground.

In step 1230, 3D data may be generated using the inclined angle received from the gravity sensor 140 and the depth image received from the image acquisition unit 100. That this, the processor 200 generates 3D data using the inclined angle received from the gravity sensor 140 and the depth image received from the image acquisition unit 100. The 3D data is three-dimensionally formed data representing the distance value acquired from the image acquisition unit 100, i.e. the distance from the user 500 to the obstacle 400. The depth image may be generated when the image acquisition unit 100 is inclined. Accordingly, when the 3D data is generated, it is necessary to consider the inclined degree of the depth image. In this case, the processor 200 generates the 3D data in consideration of the inclined degree of the image acquisition unit 100 in relation to the ground. In step 1240, the distance value, included in the 3D data, is converted into a height value. That is, the processor 200 converts the distance value included in the 3D data into a height value.

In step 1250, the motor drive 310 controls one or more protrusions 320 to extend or retract to the height value. That is, the processor 200 converts the distance value included in the 3D data to a height value of the protrusions 320 when the protrusions 320 are extended. The processor 200 generates a motor control signal including the height value. That is, the motor control signal includes the protruding height value of the protrusions 320. The processor 200 transmits the motor control signal to the motor drive 310. The motor drive 310 receives the motor control signal and drives the motor, based on the protruding height value included in the motor control signal, to control the protrusions 320 to extend or retract. Accordingly, the processor 200 controls the motor drive 310 to cause the protrusions 320 to extend or retract to the protruding height value. The processor 200 transmits, to the motor drive 310, the motor control signal, which increases or decreases the protruding height value of the protrusions 320. In addition, when the obstacle 400 is sensed on one side of the view angle of the sensor unit 120, the processor 200 controls the protrusions 320 that correspond to the side of the view angle on which the obstacle 400 is sensed to extend first.

In step 1260, the servo motor 131 maintains the inclined angle of the sensor unit 129 in relation to the ground.

That is, the processor 200 controls the servo motor 131 to maintain an inclined angle of the sensor unit 120 within a pre-set angle range. According, the processor 200 controls the servo motor 131 to drive the motor of the servo motor 131 to change the angle of the sensor unit 120. The processor 200 receives data related to the inclined angle of the sensor unit 120 in relation to the ground from the gravity sensor 140. When the received inclined angle is out of the pre-set angle range, the processor 200 controls and drives the servo motor 131 to position the sensor unit 120 within the pre-set angle range.

In step 1270, a depth image for a region obscured by the obstacle 400 or a depth image for a region outside of the range of the view angle of the sensor unit 120 is generated. When an obstacle 400 exists in front of the image acquisition unit 100, a region positioned behind the obstacle 400 cannot be sensed. Accordingly, the processor 200 generates data related to the depth image for the non-sensed region to express the non-sensed region. Additionally, the processor 200 generates data related to the depth data for a region outside of the range of the view angle of the sensor unit 120 to express the non-sensed region.

The embodiments described herein and the accompanying drawings are merely examples used to describe the technical features of the present invention and to assist in an understanding of the present invention; however, the present invention is not limited thereto. It should be understood by those skilled in the art, that in addition to the embodiments disclosed herein, all modifications and changes derived from the technical idea of the present invention, fall within the scope of the present invention. Therefore, the scope of the present invention is defined, not by the detailed description and embodiments, but by the following claims and their equivalents, and all differences within the scope will be construed as being included in the present invention.

What is claimed is:

1. An assist apparatus for a visually impaired person, the assist apparatus comprising:
an image acquisition unit, including a sensor unit,
wherein the sensor unit acquires a depth image including a distance value for an obstacle in front of the person;
a gravity sensor that detects an inclined angle of the image acquisition unit in relation to a ground surface upon which the person is walking;
at least one retractable and extendable protrusion;
a motor drive that drives a motor to cause the at least one protrusion to extend or retract; and
a processor that generates 3-Dimensional (3D) data using the detected inclined angle and the acquired depth image, converts the distance value into a height value, and controls the motor drive to cause the at least one protrusion to extend or retract to the height value.

2. The assist apparatus of claim 1, wherein the sensor unit is formed by at least one of a 3D sensor and a stereo camera.

3. The assist apparatus of claim 1, further comprising a servo motor attached to the sensor unit to adjust the inclined angle of the sensor unit in relation to the ground.

4. The assist apparatus of claim 3, wherein the servo motor further includes a motor that maintains the inclined angle of the sensor unit in relation to the ground.

5. The assist apparatus of claim 3, wherein the gravity sensor is attached to the servo motor.

6. The assist apparatus of claim 3, wherein, when the inclined angle of the sensor unit is outside of a pre-set angle range, the processor controls the servo motor to position the sensor unit within the pre-set angle range.

7. The assist apparatus of claim 3, wherein the processor generates a motor control signal that controls the servo motor to position the sensor unit within a pre-set angle range and transmits the motor control signal to the servo motor, and
the servo motor receives the motor control signal and drives the motor, in response to the motor control signal, to change the inclined angle of the sensor unit.

8. The assist apparatus of claim 1, wherein the processor generates at least one of a depth image for a region obscured by the obstacle and a depth image for a region outside of a range of a view angle of the sensor unit.

9. The assist apparatus of claim 1, wherein the at least one protrusion is formed on a plate.

10. The assist apparatus of claim 9, wherein the plate is disposed at a proximal end of the assist apparatus.

11. The assist apparatus of claim 1, wherein the at least one protrusion includes a plurality of protrusions formed in a grid shape.

12. A method of controlling an assist apparatus for a visually impaired person, the method comprising:
acquiring a depth image, including a distance value for an obstacle in front of the person, through a sensor unit;
detecting an inclined angle of the sensor unit in relation to a ground surface upon which the person is walking, through a gravity sensor;
generating 3D data using the detected inclined angle and the acquired depth image;
converting the distance value into a height value; and
controlling at least one protrusion to extend or retract to the height value.

13. The method of claim 12, wherein the sensor unit is formed by at least one of a 3D sensor and a stereo camera.

14. The method of claim 12, further comprising:
maintaining an inclined angle of the sensor unit in relation to the ground, using a servo motor.

15. The method of claim 14, wherein the gravity sensor is attached to the servo motor.

16. The method of claim 12, further comprising:
generating at least one of a depth image for a region obscured by the obstacle and a depth image for a region outside of a range of a view angle of the sensor unit.
